(19) United States
(12) Patent Application Publication
(10) Pub. No.: US 2009/0043583 A1
(43) Pub. Date: Feb. 12, 2009

(54) DYNAMIC MODIFICATION OF VOICE SELECTION BASED ON USER SPECIFIC FACTORS

(75) Inventors: Ciprian AGAPI, Lake Worth, FL (US); Oscar J. BLASS, Boynton Beach, FL (US); Oswaldo GAGO, Margate, FL (US); Roberto VILA, Hollywood, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/835,707

(22) Filed: Aug. 8, 2007

(51) Int. Cl. G10L 13/08

(52) U.S. Cl. 704/260; 704/E13.002

(57) ABSTRACT

The present invention discloses a solution for customizing synthetic voice characteristics in a user specific fashion. The solution can establish a communication between a user and a voice response system. A data store can be searched for a speech profile associated with the user. When a speech profile is found, a set of speech output characteristics established for the user from the profile can be determined. Parameters and settings of a text-to-speech engine can be adjusted in accordance with the determined set of speech output characteristics. During the established communication, synthetic speech can be generated using the adjusted text-to-speech engine. Thus, each detected user can hear a synthetic speech generated by a different voice specifically selected for that user. When no user profile is detected, a default voice or a voice based upon a user's speech or communication details can be used.

### BACKGROUND

1. Field of the Invention

The present invention relates to the field of speech processing and more particularly, to the dynamic modification of voice selection based on user specific factors.

2. Description of the Related Art

Speech processing technologies are increasingly being used for automated user interactions. Interactive voice response (IVR) systems, mobile telephones, computers, remote controls, and even toys are starting to speech interact with users. At present, users are generally left unsatisfied by conventionally implemented speech systems. In an IVR scenario, low satisfaction manifests itself by balking out of an automated system and attempting to contact a live operator. This balking reduces the cost savings associated with IVRs and increases overall cost for customer service. In an integrated device scenario, low user satisfaction results in lower sales and/or a relatively low usage of speech processing features in a device.

A problem with conventional speech processing is that they present synthetic speech in a one-size-fits-all manner, meaning each user (e.g., IVR user) is presented with the same voice for speech output. A one-size-fits-all implementation creates an impression that speech processing systems are cold and impersonal. Studies have shown that many times communicators respond better to particular types of speakers than others. For example, an Hispanic caller can feel more comfortable talking to a communicator speaking with an Hispanic accent. Similarly, a person with a strong Southern accent may find communications with similar speaking individuals more relaxing than communications with speakers rapidly speaking in a New York accent. Some situations also make hearing a male or female voice more appealing to a communicator. No current speech processing system automatically adjusts speech output parameters to suit preferences of a communicator. Such adjustments could, however, result in higher user satisfaction when interacting with voice response systems.

### SUMMARY OF THE INVENTION

The present invention discloses a solution for dynamic modification of voice output based on detectable or inferred user preferences. In the solution, a voice-enabled software application can present a user with a Text-to-Speech (TTS) voice that is specifically selected based upon a deterministic set of factors. In one embodiment, a speech profile can be established for each user that defines speech output characteristics. In another embodiment, speech characteristics of a speaker can be analyzed and settings of a speech output component can be adjusted to produce a voice that either matches the speaker's characteristics or that is determined to be likely pleasing to the user based on the speaker's characteristics.

Additional information, such as caller location in an interactive voice response (IVR) telephony situation, can be used as a factor to indicate speech output characteristics. For example, if a caller is from Tennessee as indicated by a calling number's area code, an IVR system can elect to generate speech having a Southern accent. The present invention can be used with both concatenative text-to-speech and formant implementations, since each are capable of producing output with different selectable speech characteristics. For instance, different concatenative TTS voices can be used in a concatenative implementation and different digital signal processing (DSP) parameters can be used to adjust output in a formant implementation.

The present invention can be implemented in accordance with numerous aspects consistent with the material presented herein. For example, one aspect of the present invention can include a method for customizing synthetic voice characteristics in a user specific fashion. The method can include a step of establishing a communication between a user and a voice response system. The user can utilize a voice user interface (VUI) to communicate with the voice response system. A data store can be searched for a speech profile associated with the user. When a speech profile is found, a set of speech output characteristics established for the user from the profile can be determined. Parameters and settings of a text-to-speech engine can be adjusted in accordance with the determined set of speech output characteristics. During the established communication, synthetic speech can be generated using the adjusted text-to-speech engine. Thus, each detected user can hear a synthetic speech generated by a different voice specifically selected for that user. When no user profile is detected, either a default voice can be used or a voice can be selected based upon speech input characteristics of the user. For example, a user speech sample can be analyzed and a speech output voice can be selected to match the analyzed speech patterns of the user.

Another aspect of the present invention can include a method for producing synthetic speech output that is customized for a user. In the method, at least one variable condition specific to a user can be determined. This variable condition can be a user's identity, a user's speech characteristics, a user's calling location when synthetic speech is generated for a telephone call involving voice response application and a user, and the like. Settings that vary output of a speech synthesis engine can be adjusted based upon the determined variable conditions. For a communication involving the user, speech output can be produced using the adjusted speech synthesis engine.

Still another aspect of the present invention can include a speech processing system that includes a text-to-speech engine, a speech output adjustment component, a variable condition detection component, and a data store. The text-to-speech engine can generate synthesized speech. The speech output adjustment component can alter output characteristics of speech generated by the text-to-speech engine based upon at least one dynamically configurable setting. The variable condition detection component can determine one or more variable conditions of a communication involving a user and a voice user interface that presents speech generated by the text-to-speech engine. The data store can programmatically map the variable conditions to the configurable settings. Speech output characteristics of speech produced by the text-to-speech engine can be dynamically and automatically changed from communication-to-communication based upon variable conditions detected by the variable condition detection component.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via a carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system where tailored speech output is produced based upon variable conditions, such as an identity of a user.

FIG. 2 is a flowchart of a method for customizing speech output based upon variable conditions in accordance with an embodiment of inventive arrangements disclosed herein.

FIG. 3 is a diagram of a sample scenario where customized voice output is produced in accordance with an embodiment of inventive arrangements disclosed herein.

### DETAILED DESCRIPTION OF THE INVENTION

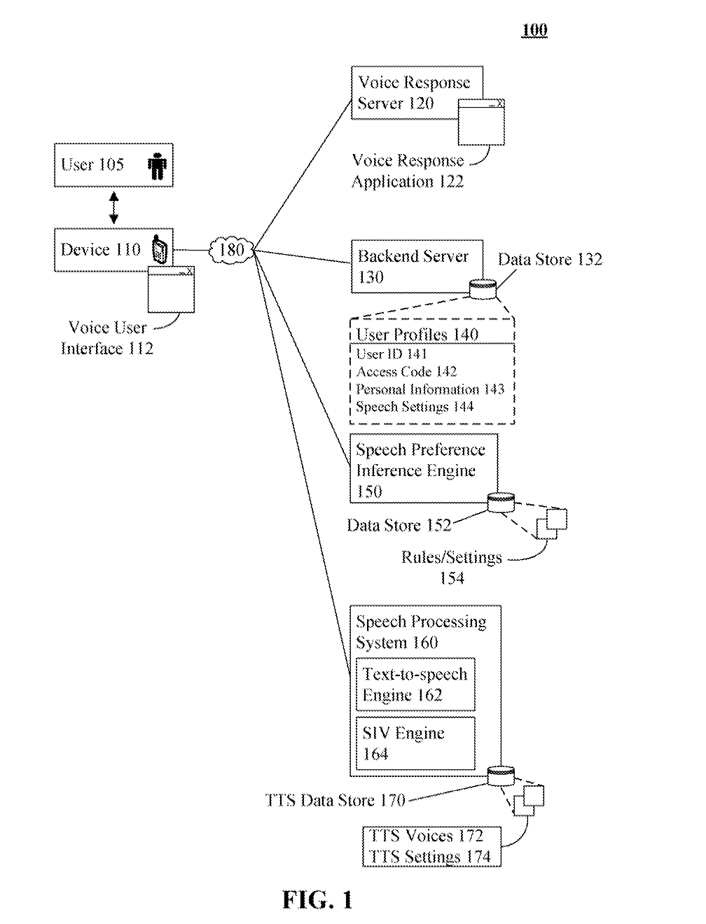

FIG. 1 is a schematic diagram of a system 100 where tailored speech output is produced based upon variable conditions, such as an identity of a user 105. More specifically, a set of user profiles 140 can be established, where each profile 140 includes a set of speech settings 144. When the user 105 interacts with a voice user interface (VUI) 112, his/her identity can be determined and speech settings 144 from a related profile can be conveyed to a speech processing system 160. The speech processing system 160 can apply the settings 144, which varies speech output characteristics of voices produced by text-to-speech engine 162. As a result, a user 105 hears a customized voice through the VUI 112,

When a customer profile 140 is not present in a data store 132 for a user 105, the speech processing system 160 can use default settings. In a different implementation, one or more situation specific conditions can be determined, which are used to alter parameters of the text-to-speech engine 162. One such condition can be user 105 location, which can be determined based upon a phone number of a call originating device 110. For example, when a user 105 is located in the Midwest, engine 162 parameters can be adjusted so speech output is generated with a Midwestern accent.

Another variable condition can be speech characteristics of user 105, where a speaker identification and verification engine 164 or other speech feature extraction component can be used to determine the speech characteristics of the user 105. Parameters of the speech processing system 160 can be adjusted so the speech output of engine 162 matches the user's 105 speech characteristics. Thus, a female user 105 speaking with a Southern accent can receive speech output in a Southern female voice. The produced speech output does not necessarily need to match those of the speakers (105), but can instead be selected to appeal to the user 105 as annotated in a set of programmatic rules (154) stored in data store 170 or 152. For example, a young male user 105 with a Northwestern accent can be mapped to a female voice with a Southern accent.

In one embodiment of system 100, a speech preference inference engine 150 can exist, which automatically determines speech output parameters based upon a set of configurable rules and settings 154. The speech inference engine 150 can utilize user 105 specific personal information 143 and/or speech characteristics to determine appropriate output characteristics. Further, once a set of speech settings 144 are determined by engine 150 for a known user 105, these settings can be stored in that user's profile 140 for later use. In one embodiment the speech settings 144 can be directly configured by a user 105 using a configuration interface (not shown).

In system 100, the text-to-speech engine 162 can utilize any of a variety of configurable speech processing technologies to generate speech output. In one embodiment, engine 162 can be implemented using concatenative TTS technologies, where a plurality of different concatenative TTS voices 172 can be stored and selectively used to generate speech output having desired characteristics. In another embodiment, the text-to-speech engine 162 can he implemented using formant based technologies. There, a set of TTS settings 174 and digital signal processing (DSP) techniques can be used to generate speech output having desired audio characteristics.

The Speaker Identification and Verification (SIV) engine 164 can be a software engine able to perform speaker identification and verification functions. In one embodiment, an identity of the user 105 can be automatically determined or verified by the SIV engine 164, which can be used to determine an appropriate profile 140. The SIV engine 164 can also be used to determine speech characteristics of the user 105, which can be used to adjust settings that affect speech output produced by the TTS engine 162.

Device 110 can be any communication device capable of permitting the user 105 to interact via VUI 112. For example, the device 110 can be a telephone, a computer, a navigation device, an entertainment system, a consumer electronic device, and the like.

The VUI 112 can be any interface through which the user 105 can interact with an automated system using a voice modality. The VUI 112 can be a voice-only interface or can be a multi-modal interface, such as a graphical user interface (GUI) having a visual and a voice modality.

The voice response server 120 can be a system that accepts a combination of voice input and/or Dual Tone Multi-Frequency (DTMF) input, which it processes to perform programmatic actions. The programmatic actions can result in speech output being conveyed to the user 105 via the VUI 112. In one embodiment, the voice response server 120 can he equipped with telephony handling functions, which permits user interactions via a telephone or other real-time voice communication stream. The voice response application 122 can be any speech-enabled application, such as a VoiceXML application.

The back end server 130 can be a computing system associated with a data store 132 which can store information for an automated voice system. For example, the back-end server 130 can be a banking server, winch the user 105 interacts with via a telephone user interface (112) with the assistance of server 120. In one embodiment, data store 132 can house information such as customer profiles 140. Customer profiles 140 can comprise of identifying information such as user ID 141, access code 142, and personal information 143. Additionally customer profiles 140 can store speech settings 144 which can be used by a speech preference engine 150 to modify TTS voice 172 selections.

Data stores 132, 152, 170 can be physically implemented within any type of hardware including, but not limited to, a magnetic disk, an optical disk, a semiconductor memory, a digitally encoded plastic memory, or any other recording medium. Each of the data stores 132, 152, 170 can be stand-alone storage units as well as a storage unit formed from a plurality of physical devices, which may be remotely located from one another. Additionally, information can be stored within each data store 132, 152, 170 in a variety of manners. For example, information can be stored within a database structure or can be stored within one or more files of a file storage system, where each file may or may not be indexed for information searching purposes. One or more of the data stores 132, 152, 170 can optionally utilize encryption techniques to enhance data security.

Network 180 can include any hardware/software/and firmware necessary to convey data encoded within carrier waves. Data can be contained within analog or digital signals and conveyed though data or voice channels. Network 180 can include local components and data pathways necessary for communications to be exchanged among computing device components and between integrated device components and peripheral devices. Network 180 can also include network equipment, such as routers, data lines, hubs, and intermediary servers which together form a data network, such as the Internet. Network 180 can also include circuit-based communication components and mobile communication components, such as telephony switches, moderns, cellular communication towers, and the like. Network 180 can include line based and/or wireless communication pathways.

The system 100 is shown as a distributed system, where a user's device 110 connects to a voice response server 120 executing a voice enabled application 122, such as a VoiceXML application. Further, the server 120 is linked to a backend server 130, a speech inference engine 150, and a speech processing system 160 via a network 180. In the shown system, the speech processing system 160 can be a middleware voice solution, such as WEBSPHERE VOICE SERVER or other JAVA 2 ENTERPRISE EDITION (J2EE) server. Other arrangements are contemplated and are to be considered within the scope of the invention. For example, the voice processing and interaction code can be contained on a sell-contained computing device accessed by user 105, such as a speech enabled kiosk or a personal computer with speech interaction capabilities.

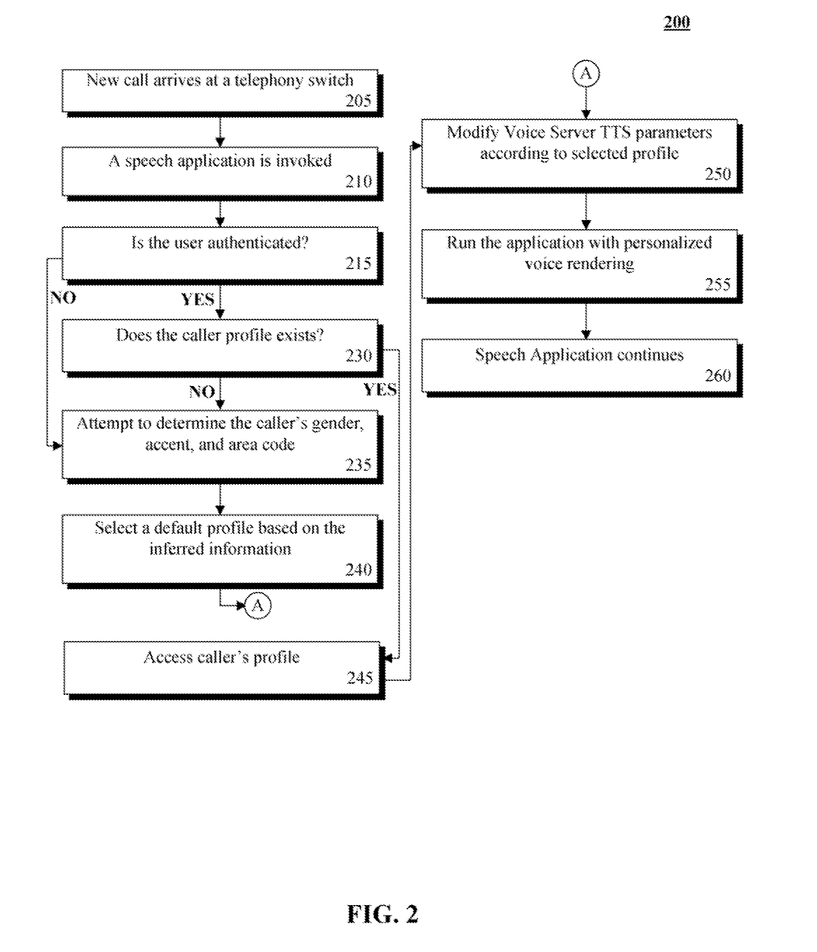

FIG. 2 is a flowchart of a method 200 for customizing speech output based upon variable conditions in accordance with an embodiment of inventive arrangements disclosed herein. Method 200 can be performed in the context of system 100.

The method 200 can begin in step 205, where a caller can interact with a voice response system, in step 210, a speech-enabled application can be invoked. In step 215, an optional user authentication action can be performed. If authentication is not performed, the method can proceed to step 235.

If a user is authenticated in step 215, the method can proceed from step 215 to step 230, where a query can be made for a user profile for the authenticated user. If no user profile exists, the method can proceed to step 235, where an attempt can be made to determine characteristics of the caller, such as speech characteristics from the caller's voice or location characteristics from call information. Any determined characteristics can be mapped to a set of profiles or if no characteristics of the user are determined, a default profile can be used, as shown by step 240. The method can proceed from step 240 to step 250, where settings associated with the selected profile can be applied to a speech processing system.

When a user profile exists in step 230, the method can progress to step 245, where that profile can be accessed and speech settings associated with the profile can be obtained. The method can proceed from step 245 to step 250, where speech processing parameters can be adjusted, such as adjusting TTS parameters so that speech output has characteristics specified in an active profile. In step 255, a speech enabled application can execute, which produces personalized speech output in accordance with the profile settings. The speech application can continue to operate in this fashion until the communication session with the user ends, as indicated by step 260.

Although not expressly shown in method 200, the method 200 can include a variety of processes performed by a standard voice response system. For example, in one implementation, a user can opt to speak with a live agent by speaking “operator” or by pressing “0” on a dial pad.

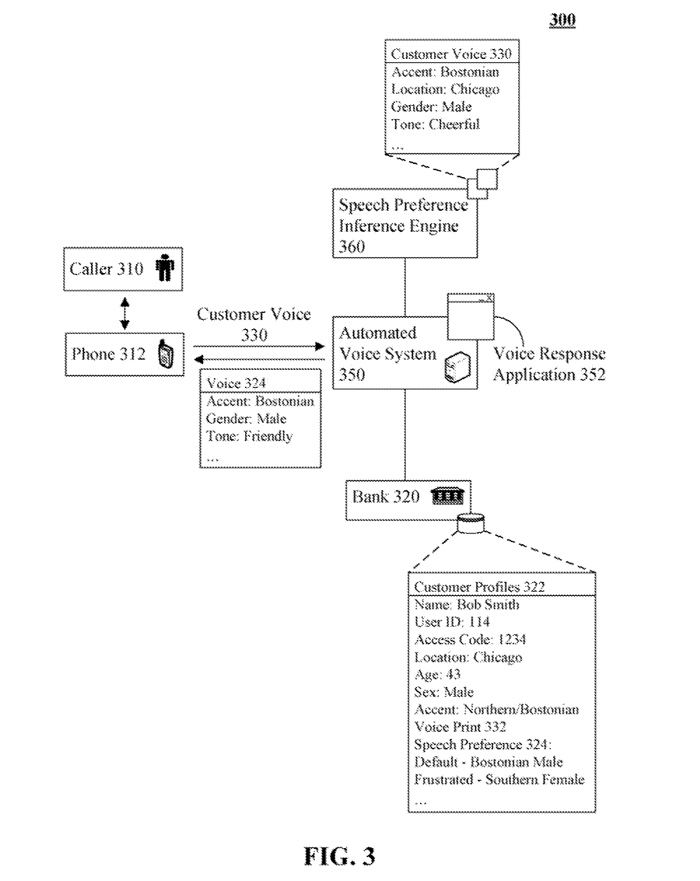

FIG. 3 is a diagram of a sample scenario 300 where customized voice output is produced in accordance with an embodiment of inventive arrangements disclosed herein. Scenario 300 can be performed in the context of system 100 or method 200.

In scenario 300, a caller 310 can use a phone 312 to interact with an automated voice system 350, which executes voice response application 352 that permits the caller 310 to interact with their bank 320. Initially, the caller 310 can be prompted for authentication information, which is provided. The automated voice system 350 can access a customer profile 322 to determine appropriate speech output settings, which are to be applied to the current communication session.

In one embodiment, multiple different speech output settings can be specified to a specific caller 310, which are to be selectively applied depending upon situational conditions. For example, speech preferences 324 can indicate that a typical interaction with caller 310 is to be conducted using a Bostonian Male voice. When the user is frustrated, however, a Southern female voice can be preferred. In one embodiment, a user's state of frustration can be automatically determined by analyzing the customer's voice 330 characteristics and comparing them against a baseline voice print 332 of the caller 310. A user's satisfaction or frustration level can also be determined based upon content of the voice 330 (e.g., swearing can indicate frustration) and/or a dialog flow of a speech session.

Further, although system 300 shows that speech preferences 324 are actually stored in the bank's 320 data store, this need not be the case. In a different implementation, a set of rules/mappings can be established by the speech preference inference engine 360, which determines an appropriate output voice for the caller 310 based upon caller personal information. This personal information can be extracted from the bank's 320 data store. For example, a name, gender, location, age, and sex can be used to determine a suitable output voice for the caller 310.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following; a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for customizing synthetic voice characteristics in a user specific fashion comprising:
establishing a communication between a user and a voice response system, wherein said user utilizes a voice user interface (VUI) to communicate with the voice response system;
searching a data store for a speech profile associated with the user;
when speech profile is found, determining a set of speech output characteristics established for the user from the profile;
setting parameters and settings of a text-to-speech engine in accordance with the determined set of speech output characteristics; and
during the established communication, generating synthetic speech to be presented to the user using the text-to-speech engine.

2. The method of claim 1, wherein the text-to-speech engine is a concatenative text-to-speech engine, said method further comprising:
providing a plurality of concatenative text-to-speech voices for use by the concatenative text-to-speech engine, wherein the speech output characteristics of the speech profile indicates one of the concatenative text-to-speech voices is to be used for communications involving the user, wherein the generated speech is generated by the concatenative text-to-speech engine in accordance with the indicated concatenative text-to-speech voice.

3. The method of claim 2, wherein speech profile indicates at least two different concatenative text-to-speech voices, each associated with at least one variable condition, said method further comprising:
determining a current state of the at least one variable condition applicable for the communication; and
selecting a concatenative text-to-speech voice associated with the current state, wherein the selected concatenative text-to-speech voice is used by the concatenative text-to-speech engine to construct the generated speech.

4. The method of claim 1, wherein the text-to-speech engine is a formant text-to-speech engine, wherein said parameters and settings alter generated speech output in accordance with the determined set of speech output characteristics.

5. The method of claim 4, wherein speech profile indicates at least two different sets of formant parameters, each associated with at least one variable condition, said method further comprising:
determining a current state of the at least one variable condition applicable for tire communication;
selecting a set of formant parameters associated with the current state; and
applying the selected formant parameters to the text-to-speech engine used to construct the generated speech.

6. The method of claim 1, wherein the voice response system utilizes a speech enabled program to interlace with the user, wherein said speech enabled program is written in voice markup language, wherein software external to the voice markup language is used to direct a machine to perform the searching, determining, and setting steps in accordance with a set of programmatic instructions stored in a data storage medium, which is readable by the machine.

7. The method of claim 1, further comprising:
when a speech profile for the user is not found, selecting a set of default speech output characteristics, which are used in the setting step.

8. The method of claim 1, further comprising:
when a speech profile for the user is not found, receiving speech input from the user;
analyzing the speech input to determine speech input characteristics of the user;
determining a set of speech output characteristics associated with the determined speech input characteristics; and
using the determined speech output characteristics in the setting step.

9. The method of claim 1, wherein the voice user interface (VUI) is a telephone user interlace (TUI) and wherein the communication is a telephone communication, said method further comprising:
determining a set of conditions specific to the telephone communication, which said conditions include a geographic region from which the telephone communication originated;
querying a data store to match the set of conditions against a set of speech output characteristics related within the data store to the set of conditions; and
using the queried speech output characteristics in the setting step.

10. The method of claim 1, wherein said steps of claim 1 are performed by at least one machine in accordance with at least one computer program stored in a computer readable media, said computer programming having a plurality of code sections that are executable by the at least one machine.

11. A method for producing synthetic speech output that is customized for a user comprising;
determining a variable condition specific to a user;
adjusting settings that vary output of a speech synthesis engine based upon the determined variable conditions; and
for a communication involving the user, producing speech output using the speech synthesis engine having settings adjusted in accordance with the adjusting step.

12. The method of claim 11, further comprising:
determining an identity of the user; and
querying a user profile store for previously established speech output settings associated with the identified user, wherein said adjusting step utilizes speech output settings returned from the querying step.

13. The method of claim 11, further comprising:
analyzing a speech input sample of the user;
determining a set of speech characteristics of the user; and
querying a data store for previously established speech output settings indexed against the determined set of speech characteristics of the user, wherein said adjusting step utilizes speech output settings returned from the querying step.

14. The method of claim 11, wherein the speech synthesis engine is a concatenative text-to-speech engine, wherein the adjusting step selects one of a plurality of concatenative text-to-speech voice based upon the determined variable conditions.

15. The method of claim 11, wherein said steps of claim 11 are performed by at least one machine in accordance with at least one computer program stored in a computer readable media, said computer programming having a plurality of code sections that are executable by the at least one machine.

16. A speech processing system comprising:
a text-to-speech engine configured to generate synthesized speech;
a speech output adjustment component configured to alter output characteristics speech generated by the text-to-speech engine based upon at least one dynamically configurable setting;
a variable condition detection component configured to determine at least one variable conditions of a communication involving a user and a voice user interface that presents speech generated by the text-to-speech engine; and
a data store that programmatically maps the at least one variable conditions to the at least one dynamically configurable setting, wherein speech output characteristics of speech produced by the text-to-speech engine is dynamically and automatically changed from communication-to-communication based upon variable conditions detected by the variable condition detection component that are mapped to configurable settings, which are automatically applied by the speech output adjustment component for each communication involving the text-to-speech engine.

17. The speech processing system of claim 16, wherein the data store comprises a plurality of user profiles that each specify user specific configurable settings for the speech output adjustment component, wherein the variable condition is an identity of the user, which is used to determine one of the user profiles, which in turn specifies the configurable settings to he applied by the speech output adjustment component for a communication involving the identified user.

18. The speech processing system of claim 16, further comprising;
a speech input analysis component configured to determine speech input characteristics from received speech input, wherein at least one of the variable conditions comprises speech input characteristics determined by the speech input analysis component.

19. The speech processing system of claim 16, wherein the text-to-speech engine is a concatenative text-to-speech engine and wherein the speech output adjustment component selects different concatenative text-to-speech voices based upon the variable conditions detected by the variable condition detection component.

20. The speech processing system of claim 16, wherein the text-to-speech engine is a turn-based speech processing engine executing within a JAVA 2 ENTERPRISE EDITION (J2EE) middleware environment, wherein the communication for which the text-to-speech engine utilizes is a real-time communication between a user and an automated voice response system, wherein dialog flow of the automated voice response system is determined by a voice response application written in a voice markup language.
